(19) United States
(12) Patent Application Publication
(10) Pub. No.: US 2025/0154424 A1
(43) Pub. Date: May 15, 2025

(54) WAX TREATMENT AND METHOD OF USE

(71) Applicant: Independence Oilfield Chemicals LLC., The Woodlands, TX (US)

(72) Inventors: Ashley GOTHARD, Fischer, TX (US); Butch GOTHARD, Canyon Lake, TX (US)

(21) Appl. No.: 18/947,595

(22) Filed: Nov. 14, 2024

Related U.S. Application Data
(63) Continuation of application No. 63/599,343, filed on Nov. 15, 2023.

(51) Int. Cl. C10L 10/04; C10L 1/185; C10L 1/238; C10L 1/26

(52) U.S. Cl. CPC C10L 10/04; C10L 1/1855; C10L 1/2381; C10L 1/2691; C10L 2200/0438

(57) ABSTRACT

A method of controlling wax deposition within a fluid, the method including admixing an additive composition with the fluid, wherein the additive composition includes one or more biosurfactants and one or more additional additives independently selected from (i) a sulfonic acid or salt thereof, (ii) a polymeric wax inhibitor and (iii) an alkoxylated alcohol and/or amine compound.

### FIELD

The invention relates to a method of controlling wax deposition within a fluid using one or more biosurfactants, and to the use of one or more biosurfactants to control wax deposition within a fluid. The invention also relates to an additive composition comprising one or more biosurfactants.

### BACKGROUND

Wax (or paraffin) deposition is known to occur in fluids in various processes relating to oil and gas, such as during the production, transportation and storage of oil and gas and the refining of petroleum products. For example, wax deposition may occur in downhole, flowline and pipeline systems during oil and gas production. During production and transport of crude oil, waxes present within the crude oil deposit onto the surface of the formation or wellbore in addition to equipment such as the production casing through which the crude oil is extracted. This causes operating pressures to increase and production volumes to decrease, and can in some cases make it necessary to stop processes to allow for removal of deposits. These issues reduce process efficiency and increases costs. Waxes may also precipitate out during transport, especially in pipelines and/or storage of crude oil. This reduces the ability to transport the crude oil which increases transport costs. In extreme cases the pumping of crude oil needs to be stopped to mechanically remove wax deposits from pipelines.

It is known to use conventional wax dispersants to disperse wax that forms in a fluid, which conventional wax dispersants may also act to disperse the wax once formed into an oil phase of the fluid. However, conventional wax dispersants are not always effective and problems still exist due to wax deposition. Thus, there is a need for alternative and/or improved methods for controlling wax deposition, which methods may provide improvements in terms of improved wax dispersion once the wax has formed and/or inhibition or prevention of the formation of wax, so that there is a reduced need to disperse wax. These improvements would provide increased efficiency and/or reduced costs.

It is thus an object of the present invention to provide methods for controlling wax deposition within a fluid, which methods may be more effective than, or which may provide an alternative to, existing methods for controlling wax deposition within a fluid.

### SUMMARY

According to a first aspect of the invention, there is provided a method of controlling wax deposition within a fluid, the method comprising admixing an additive composition with the fluid, wherein the additive composition comprises one or more biosurfactants and one or more additional additives independently selected from (i) a sulfonic acid compound or a salt thereof, (ii) a polymeric wax inhibitor and (iii) an alkoxylated alcohol and/or amine compound.

According to a second aspect of the invention, there is provided the use of an additive composition to control wax deposition within a fluid, wherein the additive composition comprises one or more biosurfactants and one or more additional additives independently selected from (i) a sulfonic acid compound or a salt thereof, (ii) a polymeric wax inhibitor and (iii) an alkoxylated alcohol and/or amine compound.

According to a third aspect of the invention, there is provided an additive composition comprising one or more biosurfactants and one or more additional additives independently selected from (i) a sulfonic acid compound or a salt thereof, (ii) a polymeric wax inhibitor and (iii) an alkoxylated alcohol and/or amine compound.

According to a fourth aspect of the invention, there is provided an admixture comprising a fluid and an additive composition according to the third aspect of the invention.

According to a fifth aspect of the invention, there is provided a method of making an admixture according to the fourth aspect, the method comprising admixing an additive composition according to the third aspect and a fluid.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “aryl” as used herein relates to an organic moiety derived from an aromatic hydrocarbon by removal of one hydrogen, and includes any monocyclic, bicyclic or polycyclic carbon ring of up to 7 members in each ring, wherein at least one ring is aromatic.

The term “hydrocarbyl” is used in its ordinary sense, which is well-known to those skilled in the art. Specifically, it refers to a group having a carbon atom directly attached to the remainder of the molecule and having predominantly hydrocarbon character.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

In this specification any reference to ppm is to parts per million by volume.

According to a first aspect of the invention, there is provided a method of controlling wax deposition within a fluid, the method comprising admixing an additive composition with the fluid, wherein the additive composition comprises one or more biosurfactants and one or more additional additives independently selected from (i) a sulfonic acid compound or a salt thereof, (ii) a polymeric wax inhibitor and (iii) an alkoxylated alcohol and/or amine compound.

According to a second aspect of the invention, there is provided the use of an additive composition to control wax deposition within a fluid, wherein the additive composition comprises one or more biosurfactants and one or more additional additives independently selected from (i) a sulfonic acid compound or a salt thereof, (ii) a polymeric wax inhibitor and (iii) an alkoxylated alcohol and/or amine compound.

By controlling (or to control) wax deposition within a fluid, we mean to inhibit the formation of wax in the fluid and/or to disperse wax that is present in the fluid. Preferably, controlling (or to control) wax deposition within a fluid both inhibits the formation of wax in the fluid and disperses wax that is present in the fluid. For example, the wax may be present in the fluid as a suspension or dispersion therein and/or may be deposited on a surface of a conduit through which the fluid flows. For example, the wax may initially be deposited on a surface of a conduit through which the fluid flows and the wax may become removed from the surface to become suspended or deposited in the fluid.

The inhibition of the formation of wax may comprise preventing or reducing the formation of wax crystals in a form in which they precipitate out of the fluid.

The additive composition may be used in gas lift and capillary lift operations.

The additive composition may be used with fluids being transported through any suitable conduit, such as a pipeline.

The dispersion of wax that is present in the fluid may, for example, comprise the dispersion of wax that has formed in the fluid and/or of wax that has entered the fluid having already formed. Wax may for example form on a surface of an interior of a receptacle (such as a wellbore or pipeline) for the fluid and then become removed from the surface to become dispersed within the fluid. The dispersion of wax may comprise the break down of wax into smaller particle sizes which can be efficiently dispersed and/or removed from the fluid. Such reductions in particle sizes can be measured using standard techniques well known to persons skilled in the art such as sieving and photo-analysis techniques.

The fluid referred to herein may be any fluid in which wax may form and/or deposit. The fluid may be gaseous or liquid at the temperatures used. Suitably the fluid is an aqueous fluid or a hydrocarbon fluid, or a combination thereof.

Preferably, the fluid is an aqueous fluid. Examples of suitable aqueous fluids include water, produced water, brines, flow-back water and aqueous emulsions (such as aqueous crude oil emulsions).

Suitably, the fluid is a hydrocarbon fluid. Suitable hydrocarbon fluids may be selected from a residual fuel oil (such as high sulfur fuel oil, very low sulfur fuel oil and ultra low sulfur fuel oil), a distillate fuel oil, a bio-derived fuel oil, a cracked process stream, a synthetic fuel, a gas oil (such as vacuum gas oil, light heating oil, diesel and middle distillate) and a plastic pyrolysis oil. For example, in particular, the hydrocarbon may be selected from crude oil, heavy fuel oil, gasoline, kerosenes, diesel fuels, transformer oils, turbine oils, heating oils, marine fuels, bunker oils and lubricating oils. Preferably the hydrocarbon is crude oil.

By the term wax we mean a paraffin wax, for example which may comprise straight chain saturated hydrocarbons with carbon atoms ranging from C18 to C36.

It is believed that the additive composition, and particularly the one or more biosurfactants therein, acts to reduce the particle size of formed wax into smaller particle sizes, which allows for efficient dispersion of the wax.

In the method or use according to the invention, the wax deposition within a fluid may be controlled (for example improved or reduced) by inhibiting the formation of wax in the fluid and/or by dispersing wax that is present in the fluid.

In order to provide the method or use of the invention, the fluid may be admixed with or added to the additive composition comprising one or more biosurfactants and one or more further additives, i.e. to provide an admixture. Thus, according to a fourth aspect of the invention, there is provided an admixture comprising a fluid and an additive composition according to the third aspect of the invention. According to a fifth aspect of the invention, there is provided a method of making an admixture according to the fourth aspect, the method comprising admixing an additive composition according to the third aspect and a fluid.

The fluid and the additive composition may be admixed using any suitable method, which methods would be well known to persons skilled in the art. For example, the additive composition may be admixed with the fluid in a batch wise manner, in a continuous manner or according to a batch and soak method, i.e. wherein the additive composition is added to the fluid in a process in which it is preceded and/or followed by addition of a suitable volume (or slug) of a suitable solvent (such as water, diesel and/or an alkylbenzene solvent). As would be appreciated by a person skilled in the art, the method by which the fluid and the additive composition are admixed will depend on the location of use, such as whether the treatment of the fluid is being conducted downhole, or in a flowline or in production equipment at the surface.

For example, if the treatment is being conducted downhole then the additive composition may be admixed with the fluid by injection of the additive composition into a fluid stream or through a capillary tube.

The method or use of the invention may be conducted alongside mechanical means to assist in breaking up any wax deposits that are present in the fluid. Such mechanical means would be well known to persons skilled in the art and include the use of pigs.

The method of the first aspect of the invention comprises admixing an additive composition comprising one or more biosurfactants and one or more additional additives as defined herein with a fluid. The use of the second aspect of the invention refers to the use of an additive composition comprising one or more biosurfactants and one or more additional additives as defined herein to control wax deposition within the fluid. Thus, the method and use of the invention make use of one or more biosurfactants, wherein the one or more biosurfactants are comprised in an additive composition, such as an additive composition according to the third aspect of the invention. Thus, the method or use of the invention may utilise an additive composition according to the third aspect of the invention.

According to a third aspect of the invention, there is provided an additive composition comprising one or more biosurfactants and one or more additional additives independently selected from (i) a sulfonic acid compound or a salt thereof, (ii) a polymeric wax inhibitor and (iii) an alkoxylated alcohol and/or amine compound.

References herein to one or more biosurfactants includes mixtures of different biosurfactants when more than one biosurfactant is used.

By the term biosurfactant we mean a surfactant that is produced by microorganisms, for example which may be a product of a fermentation process. Typically, a biosurfactant is generated as a metabolic product during bacterial, fungal or algal fermentation, and the metabolic product may be further derivatised. Thus, references herein to a biosurfactant refer to biosurfactants that are direct metabolic products of bacterial, fungal or algal fermentation, as well as derivatives of the direct metabolic products. Similarly, references herein to a specific biosurfactant also refer to derivatives of that biosurfactant unless otherwise stated.

The use of biosurfactants in the method and use of the invention is advantageous, because biosurfactants are natural products, are generated in a sustainable way, are environmentally benign and typically have low toxicity.

Biosurfactants are typically classified in four categories as polymeric biosurfactants, lipopeptides (or also called proteo-lipids), phospholipids and glycolipids. The one or more biosurfactants may be a complex mixture of biosurfactants.

Biosurfactants may comprise one or more fatty acid and/or fatty alcohol residues. Suitably biosurfactants useful in the invention comprise one or more fatty acid residues.

The one or more fatty acid and/or fatty alcohol residues that may be present in the biosurfactants may be the same or different and may be derived from any suitable fatty acid and/or fatty alcohol, preferably from a naturally occurring fatty acid and/or fatty alcohol. Fatty acid residues are mostly derived from natural plant oils in the form of triglycerides. For example, biocatalysts may hydrolyse lipid esters in natural plant oils forming fatty acids and glycerol. Suitably, the fatty acid and/or fatty alcohol residues may comprise a branched or unbranched, saturated or unsaturated, hydrocarbyl group.

The fatty acid and/or fatty alcohol residues that may be present in the biosurfactants may comprise from 4 to 50 carbon atoms, for example from 6 to 30 carbon atoms, preferably from 8 to 24 carbon atoms, more preferably from 12 to 22, or from 14 to 20 or from 16 to 18 carbon atoms. Preferred biosurfactants may therefore comprise residues of fatty acids derived from oleic acid, hydroxy substituted oleic acid (such as ricinoleic acid), palmitic acid and vegetable oils (such as sunflower, corn, soya, safflower oil and rapeseed oil).

Any suitable biosurfactant(s) may be used. For example, the one or more biosurfactants may be independently selected from a glycolipid, a lipopeptide, a phospholipid and a polymeric biosurfactant (and mixtures thereof).

The one or more biosurfactants may each have any suitable molecular weight, such as a molecular weight of from 200 to 3000 g mol⁻¹, for example from 250 to 2000 g mol⁻¹, such as from 500 to 1500 g mol⁻¹.

The one or more biosurfactants may be glycolipids. Glycolipids comprise one or more carbohydrate residues in addition to the one or more fatty acid and/or fatty alcohol residues. The carbohydrate and fatty acid/fatty alcohol residues are joined either by means of a linker group or a direct bond, for example via an ester, amide or glycosidic bond.

Suitable glycolipids may comprise one or more carbohydrate residues selected from rhamnose, trehalose, sophorose, mannose, galactose, glucose, cellobiose, glucosamine, sulfoquinovose, fructose, xylose, sucrose, lactose, maltose, sorbitol, erythritol and/or mannitol residues. For example, the one or more carbohydrate residues may be selected from rhamnose, trehalose, sophorose, mannose, erythritol, galactose, cellobiose and/or glucose residues. Preferably, the one or more carbohydrate residues may be selected from rhamnose, trehalose, sophorose, mannose and/or erythritol residues. More preferably, the one or more carbohydrate residues may be selected from sophorose and/or rhamnose residues. Most preferably, the one or more carbohydrate residues may be sophorose residues.

Suitable glycolipids may be selected from one or more of a rhamnolipid, a trehalolipid, a sophorolipid, a mannosylerythritol lipid, a glycolipid produced by Meyerozama guilliermondii, Saccharomyces cerevisiae, Candida utilis, Candida bombicola and/or Marinobacter hydrocarbonoclasticus.

For example, suitable glycolipids may be selected from one or more of a rhamnolipid, a trehalolipid, a sophorolipid and/or a mannosylerythritol lipid. Suitably, the one or more biosurfactants are sophorolipids.

For example, the one or more biosurfactants may be independently selected from a rhamnolipid, a trehalolipid, a sophorolipid and a mannosylerythritol lipid. The one or more biosurfactants may be selected from one or more rhamnolipids and/or one or more sophorolipids. Suitably, the one or more biosurfactants are sophorolipids.

Rhamnolipids comprise a rhamnose residue. Examples of suitable rhamnolipids may include those produced by species of Pseudomonas, Lysinibacillus and/or Serratia, for example those produced by Pseudomonas aeruginosa, Pseudomonas cepacia, Lysinibacillus sphaericus and/or Serratia rubidaea.

Trehalolipids comprise a trehalose residue. Examples of suitable trehalolipids may include those produced by species of Nocardia, Rhodococcus, Starmerella, Arthrobacter, Corynebacterium and/or Candida, for example those produced by Rhodococcus erythropolis, Nocardia farcinica and/or Candida bombicola (also known as Starmerella bombicola).

Sophorolipids comprise a sophorose residue. Examples of suitable sophorolipids may include those produced by species of Candida, Starmerella and/or Cutaneotrichosporon, for example those produced by Candida sphaerica, Starmerella bombicola and/or Cutaneotrichosporon mucoides. Suitable sophorolipids may exist in the “lactonic” form wherein a fatty acid residue is bonded separately to each ring of the sophorose residue to form a lactonic macrocycle. When the fatty acid residue is not bonded to a sophorose residue this may be known as the “acidic” form. Suitable sophorolipids may have a molar ratio of acidic to lactonic form in the range 99:1 to 1:99, for example in the range 50:50 to 60:40. Suitable sophorolipids may have a molar ratio of acidic to lactonic form of 70:30. Suitably, greater than 60%, for example greater than 70%, preferably greater than 80%, more preferably greater than 90%, of the sophorolipids may comprise an unsaturated fatty acid and/or fatty alcohol residue.

Mannosylerythritol lipids comprise a mannose residue and an erythritol residue, preferably joined by an ether bond. Examples of suitable mannosylerythritol lipids may include those produced by species of Pseudozyma and/or Ustilago, for example Pseudozyma aphidis or Pseudozyma antarctica.

The one or more biosurfactants may be lipopeptides. Lipopeptides comprise one or more peptide residues in addition to the one or more fatty acid and/or fatty alcohol residues. The one or more peptide residues may be cyclic peptide residues. Suitable lipopeptides may include surfactins, lichenysins, and/or those produced by Pseudomonas azotoformans, Bacillus velezensis, Bacillus pseudomycoides, Virgibacillus salaries, Bacillus cereus, Bacillus pumilius or Halomonas species.

Surfactins may be produced by Bacillus species, such as B. subtillis or B. nealsonii.

Lichenysins may be produced by Bacillus species, such as B. licheniformis.

For example, the one or more biosurfactants may be independently selected from surfactin and lichenysin.

The one or more biosurfactants may be phospholipids. Phospholipids comprise one or more phosphate groups in addition to the one or more fatty acid and/or fatty alcohol residues. Phospholipids may further comprise a linker group joining the one or more phosphate groups and the one or more fatty acid and/or fatty alcohol residues. Suitable linker groups may for example comprises an alcohol residue such as glycerol or sphingosine. Suitable phospholipids include those produced by species of Acinetobacter and/or Acidithiobacillus, for example Acidithiobacillus thiooxidans.

The one or more biosurfactants may be polymeric biosurfactants. Polymeric biosurfactants are biopolymers (e.g. polysaccharides, polypeptides) comprising fatty acid and/or fatty alcohol residues.

Suitable polymeric biosurfactants include cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin, cyclodextrin, inulin, alginates, amylose, amylopectin, liposan, rufisan, emulsan, lipomanan and/or alasan. Polymeric biosurfactants may include those produced by species of Candida and/or Acinetobacter, for example Candida lipolytica, Acinetobacter Iwoffi and/or Acinetobacter radioresistens.

For example, the one or more biosurfactants may be independently selected from liposan, rufisan, emulsan and alasan.

For example, the one or more biosurfactants may be independently selected from a rhamnolipid, a trehalolipid, a sophorolipid, a mannosylerythritol lipid, surfactin, lichenysin, liposan, rufisan, emulsan and alasan.

Biosurfactants useful in the invention may be those produced by species of Pseudomonas, Lysinibacillus, Serratia, Nocardia, Rhodococcus, Candida, Starmerella, Cutaneotrichosporon, Pseudozyma, Meyerozyma, Saccharomyces, Marinobacter, Bacillus, Lactobacillus Virgibacillus, Halomonas, Thiobacillus, Acidithiobacillus, Klebsiella, Alcanivorax, Arthrobacter, Rhodotorula, Tsukamurella, Ustilago, Sphingomonas, Mycobacterium, Streptomyces, Gluconobacter, Aspergillus and/or Acinetobacter.

The biosurfactants that are produced by a specific micro-organism may vary depending on the feedstock used and other variables in the growth conditions (e.g. temperature, pH, agitation and dissolved oxygen). Preferably, feedstocks comprise carbohydrates and/or lipids. Preferred lipid feedstocks are in the form of triglycerides. The feedstocks may comprise agricultural and/or industrial waste, for example vegetable oils, animal or vegetable fats, cooking oil waste, whey, glycerol, and/or combinations thereof. Biosurfactants suitable for the invention are preferably produced by micro-organisms from feedstock comprising carbohydrate and one or more lipids. More preferably, they are produced from feedstock comprising carbohydrate and one or more of vegetable oils (for example rapeseed, palm, sunflower, corn, soya and/or safflower oils), animal fats and vegetable fats.

Biosurfactants useful in the invention may be recovered from the fermentation broth before use by known recovery methods. For example, the biosurfactants may be recovered by precipitation, filtration (including ultrafiltration), adsorption to solid supports, centrifugation, chromatography (e.g. ion-exchange chromatography), foam fractionation, liquid-liquid extraction, and/or gravity separation (decanting).

Biosurfactants useful in the invention may be used as crude extracts, or they may undergo further purification and/or derivatisation before use.

Where biosurfactants are further purified, this may involve one or more purification techniques available to the skilled person, for example chromatographic techniques, ultrafiltration or washing with a suitable solvent (which solvent may be polar or non-polar).

Where biosurfactants are further derivatised, this may comprise derivatisation of the fatty acid and/or fatty alcohol residues. Where the fatty acid or fatty alcohol residue has an unsaturated alkyl group, suitable methods for derivatisation of the fatty acid or fatty alcohol residue include mild reductive, strong reductive or oxidative ozonolysis with sodium periodate (resulting in a dialdehyde, diol or diacid respectively); dihydroxylation, for example with OsO₄; epoxidation, for example with m-chloroperoxybenzoic acid; reduction, for example with H₂ on a Pd/C catalyst; ring opening metathesis; treatment with HBr; or mono-hydroxylation, for example by hydroboration with an oxidative work-up.

Where the biosurfactant is a glycolipid, the carbohydrate may be derivatised at the alcohol groups by esterification (e.g. with an anhydride), carboxymethylation (e.g. with an α-chloro acid), oxidation (to e.g. aldehyde or carboxylic acid), reaction with a non-ionic epoxide (e.g. ethylene oxide, propylene oxide), reaction with a cationic epoxide (e.g. glycidyltrimethyl ammonium chloride). The carbohydrate may be further derivatised by oxidative ring opening (e.g. with a periodate) resulting in a dialdehyde.

Derivatives of biosurfactants comprising aldehyde groups may be further derivatised, for example to alcohols, carboxylic acids, esters, amides, imines and/or amines. Derivatives of biosurfactants comprising carboxylic acid groups may be further derivatised, for example to esters and/or amides. Derivatives of biosurfactants comprising 1,2-diol groups may be further derivatised, for example by C—C bond cleavage with periodate or peroxide, or reaction with an aldehyde.

The additive composition may comprise the one or more biosurfactants in any suitable amount. For example, the additive composition may comprise at least 0.1 wt %, such as at least 0.2 wt % of the one or more biosurfactants, and/or the additive composition may comprise up to 15 wt %, such as up to 12 wt %, of the one or more biosurfactants. The additive composition may, for example, comprise from 0.1 to 15 wt %, for example from 0.1 to 12 wt %, or may comprise from 0.2 to 15 wt %, for example from 0.2 to 12 wt %, of the one or more biosurfactants.

In addition to the one or more biosurfactants, the additive composition comprises one or more additional additives independently selected from (i) a sulfonic acid compound or a salt thereof, (ii) a polymeric wax inhibitor and (iii) an alkoxylated alcohol and/or amine compound (including combinations thereof). The additive composition may comprise one or more of the additives (i), (ii) and (iii).

The additive composition may comprise any combination of the one or more additional additives independently selected from (i) a sulfonic acid compound or a salt thereof, (ii) a polymeric wax inhibitor and (iii) an alkoxylated alcohol and/or amine compound. For example, the additive composition may comprise one or more sulfonic acid compounds or salts thereof and no polymeric wax inhibitor or alkoxylated alcohol and/or amine compound, or the additive composition may for example comprise one or more sulfonic acid compounds or salts thereof and one or more polymeric wax inhibitors and no alkoxylated alcohol and/or amine compound, and so on covering all possible combinations of the additional additives (i), (ii) and (iii).

The additive composition may comprise one or more of each of the additional additives (when present) and may comprise mixtures of different additional additives when more than one such additive is used. For example, when reference is made to the additive composition comprising a sulfonic acid compound or a salt thereof, this includes mixtures of different sulfonic acid compounds or salts thereof when more than one sulfonic acid compound or salt thereof is comprised in the additive composition (with the same applying to the polymeric wax inhibitors and alkoxylated alcohol and/or amine compounds). For example, the additive composition may comprise one or more, such as two or more, sulfonic acid compounds or salts thereof (and the same for the polymeric wax inhibitors and alkoxylated alcohol and/or amine compounds when present).

The one or more additional additives in the additive composition may be one or more sulfonic acid compounds or salts thereof.

The one or more additional additives in the additive composition may be one or more sulfonic acid compounds or salts thereof and one or more polymeric wax inhibitors.

The one or more additional additives in the additive composition may be one or more sulfonic acid compounds or salts thereof and one or more alkoxylated alcohol and/or amine compounds.

The one or more additional additives in the additive composition may be one or more sulfonic acid compounds or salts thereof, one or more polymeric wax inhibitors and one or more alkoxylated alcohol and/or amine compounds.

The one or more additional additives in the additive composition may be one or more polymeric wax inhibitors.

The one or more additional additives in the additive composition may be one or more polymeric wax inhibitors and one or more alkoxylated alcohol and/or amine compounds.

The one or more additional additives in the additive composition may be one or more alkoxylated alcohol and/or amine compounds.

The one or more additional additives in the additive composition may be one or more sulfonic acid compounds or salts thereof and one or more alkoxylated alcohol compounds.

The one or more additional additives in the additive composition may be one or more sulfonic acid compounds or salts thereof, one or more polymeric wax inhibitors and one or more alkoxylated alcohol compounds.

The one or more additional additives in the additive composition may be one or more polymeric wax inhibitors and one or more alkoxylated alcohol compounds.

The one or more additional additives in the additive composition may be one or more alkoxylated alcohol compounds.

The one or more additional additives in the additive composition may be one or more sulfonic acid compounds or salts thereof, one or more polymeric wax inhibitors and one or more alkoxylated alcohol compounds.

Any suitable sulfonic acid compound or salt thereof may be included in the additive composition.

Examples of suitable sulfonic acid compounds or salts thereof include alkyl sulfonic acid compounds, aryl sulfonic acid compounds and alkyl aryl sulfonic acid compounds, and salts thereof. The alkyl sulfonic acid compounds (and salts thereof) may comprise C10 to C16 alkyl groups. The aryl sulfonic acid compounds (and salts thereof) may comprise any suitable aryl group such as a phenyl or naphthalenyl group. The alkyl aryl sulfonic acid compounds (and salts thereof) may comprise a C10 to C16 alkyl-benzene group or C10 to C16 alkyl-naphthalenyl group (especially a C10 to C16 alkyl-benzene group). References to a C10 to C16 alkyl-benzene group and suchlike mean that the alkyl group contains from 10 to 16 carbon atoms. For example, suitable sulfonic acid compounds include dodecyl benzene sulfonic acid (DDBSA) and benzene sulfonic acid.

Any suitable salt of a sulfonic acid compound may be included in the additive composition. Examples of suitable salts include amine or metal salts, such as isopropyl amine, sodium or potassium salts.

The additive composition may comprise the one or more sulfonic acid compounds or salts thereof (when present) in any suitable amount. For example, the additive composition may comprise at least 1 wt %, for example at least 2 wt %, such as at least 4 wt %, of the one or more sulfonic acids or salts thereof, and/or the additive composition may comprise up to 40 wt %, such as up to 38 wt % of the one or more sulfonic acids or salts thereof. The additive composition may, for example, comprise from 1 to 40 wt %, such as from 2 to 40 wt % or from 2 to 38 wt % or from 4 to 38 wt % of the one or more sulfonic acids or salts thereof.

Any suitable alkoxylated alcohol and/or amine compound may be included in the additive composition.

The additive composition may comprise one or more alkoxylated alcohol and/or amine compounds, suitably one or more alkoxylated polyol and/or polyamine compounds. References herein to one or more alkoxylated alcohol and/or amine compounds refer to both the alcohol and the amine compounds being alkoxylated, i.e. to one or more alkoxylated alcohol and/or alkoxylated amine compounds. Similarly, references herein to one or more alkoxylated polyol and/or polyamine compounds refer to both the polyol and the polyamine compounds being alkoxylated, i.e. to one or more alkoxylated polyol and/or alkoxylated polyamine compounds.

By an “alkoxylated alcohol compound” we mean to include any compound including one or more hydroxy functional group which has been reacted with at least one alkylene oxide moiety, i.e. such that the compound comprises one or more hydroxy functional groups and at least one alkylene oxide residue. Such compounds will be known to persons skilled in the art and may comprise further functional groups. For example, an alkoxylated alcohol compound may comprise one or more amine functional groups in addition to the one or more hydroxy functional groups and at least one alkylene oxide residue. Thus, the alkoxylated alcohol compound may be an alkoxylated alkanolamine compound.

By an “alkoxylated amine compound” we mean to include any compound including one or more amine functional groups and which has been reacted with at least one alkylene oxide moiety, i.e. such that the compound comprises one or more amine functional groups and at least one alkylene oxide residue. Such compounds will be known to persons skilled in the art and may comprise further functional groups. For example, an alkoxylated amine compound may comprise one or more hydroxy functional groups in addition to the one or more amine functional groups and at least one alkylene oxide residue. Thus, the alkoxylated amine compound may be an alkoxylated alkanolamine compound.

The additive composition may comprise any suitable alkoxylated alcohol and/or amine compound(s). Suitable alkoxylated alcohol and/or amine compound(s) may have a hydrophilic-lipophilic balance (HLB) value of from 10 to 14, for example from 11 to 13 or from 11.9 to 12.1, such as about 12. The additive composition may comprise an alkoxylated alcohol compound, or an alkoxylated amine compound, or an alkoxylated alcohol compound and an alkoxylated amine compound.

Preferably the alkoxylated alcohol and/or amine compounds include more than one alkylene oxide residue.

Suitable alkylene oxide residues include ethylene oxide residues, propylene oxide residues, butylene oxide residues and mixtures thereof. Preferably the alkoxylated alcohol and/or amine compounds include ethylene oxide residues, propylene oxide residues, or mixtures thereof.

The one or more alkoxylated alcohol and/or amine compounds may each comprise one or more alkylene oxide residues independently selected from ethylene oxide residues, propylene oxide residues and butylene oxide residues. The one or more alkoxylated alcohol and/or amine compounds may each comprise one or more alkylene oxide residues independently selected from ethylene oxide residues and propylene oxide residues.

The one or more alkoxylated alcohol compounds may be independently selected from an alkoxylated monoalcohol and an alkoxylated polyol (which may be an alkoxylated diol). By polyol we mean a compound including two or more hydroxy groups (including a diol compound).

The one or more alkoxylated amine compounds may be independently selected from an alkoxylated monoamine and an alkoxylated polyamine (which may be an alkoxylated diamine). By polyamine we mean a compound including two or more amine groups (including a diamine compound).

Suitable alkoxylated alcohol and amine compounds for use herein may have the formula A-(RO)ₙ—H wherein A is the residue of an alcohol and/or an amine compound (such as the residue of an alcohol or an amine compound), RO is an alkylene oxide residue (i.e. wherein R represents an alkylene moiety) and n is an average value of at least one (the alkoxylated compounds comprising a distribution of alkylene oxide groups). When A is the residue of an alcohol and an amine compound, the alkoxylated alcohol and amine compound may be an alkoxylated alkanolamine compound.

R is preferably an ethylene, propylene or butylene group. R may be an n-propylene or n-butylene group or an isopropylene or isobutylene group. For example R may be —CH₂CH₂—, —CH₂CH₂CH₂—, —CH₂CH₂CH₂CH₂—, —CH₂CH(CH₃)—, —CH₂C(CH₃)₂—, —CH(CH₃)CH(CH₃)— or —CH₂CH(CH₂CH₃)—. For example R may be —CH₂CH₂—, —CH₂CH(CH₃)—, —CH₂C(CH₃)₂—, —CH(CH₃)CH(CH₃)— or —CH₂CH(CH₂CH₃)—. R may comprise a mixture of isomers. For example when R is propylene, the alkylene oxide residue may include the moieties —CH₂CH(CH₃)— and —CH(CH₃)CH₂— in any order within the chain.

Each R may be the same or different. R may comprise a mixture of different alkylene moieties, for example ethylene, propylene or butylene moieties.

Preferably R is ethylene and/or propylene. More preferably R is —CH₂CH₂— and/or —CH(CH₃)CH₂—, such as —CH₂CH₂— or —CH(CH₃)CH₂—. Even more preferably, R is ethylene.

n is at least 1. Preferably for an alkoxylated amine compound n is from 5 to 1000, preferably from 5 to 500, more preferably from 10 to 400, more preferably from 15 to 300, preferably from 20 to 250, suitably from 30 to 200, preferably from 50 to 150. Preferably for an alkoxylated alcohol compound n is from 1 to 15, preferably from 2 to 10, more preferably from 4 to 8.

A is the residue of an alcohol and/or amine compound, such as the residue of an alcohol or an amine compound. For example, A may be the residue of an alcohol compound having at least one hydroxy group (including the residue of a polyol). Suitable alcohol compounds may comprise from 1 to 30 carbon atoms, such as from 2 to 16 or from 8 to 16 carbon atoms. Suitable alcohol compounds may include alcohols comprising from 2 to 5 carbon atoms (such as propanediol), fatty alcohols (such as C6 to C18 fatty alcohols) and alkyl phenol compounds (including alkylphenol resins). Suitable alkylphenol resins may be formed by condensing an alkylphenol compound with a suitable aldehyde compound such as formaldehyde (or a reactive equivalent thereof). For example, A may be the residue of an amine compound having at least one NH group (including the residue of a polyamine). Suitable amine compounds include primary or secondary monoamines having hydrocarbon substituents of 1 to 30 carbon atoms. For example, A may be the residue of an alkanolamine compound, such as a residue of monoethanolamine, diethanolamine, triethanolamine or isopropanolamine.

Examples of suitable alkoxylated alcohol compounds include alkoxylated alcohol compounds wherein the alcohol comprises from 2 to 5 carbon atoms, such as alkoxylated propanediol, for example ethoxylated and/or propoxylated propanediol.

Examples of suitable alkoxylated alcohol compounds include alkoxylated fatty alcohol compounds, alkoxylated alkylphenol compounds and alkoxylated alkylphenol resins.

For example, the alkoxylated alcohol compound may comprise an alkoxylated (preferably ethoxylated) fatty alcohol compound comprising an alcohol residue derived from a C6 to C18, fatty alcohol and an alkylene oxide residue (preferably an ethylene oxide residue), wherein the average number of alkylene oxide groups per fatty alcohol is 2 to 10. In other words, the alkoxylated alcohol compound may have the formula A-(RO)ₙ—H wherein A is the residue of a C6 to C18 fatty alcohol, RO is an alkylene oxide (preferably ethylene oxide) residue (i.e. wherein R represents an alkylene, preferably ethylene, moiety) and n is an average value of 2 to 10.

For example, the alkoxylated alcohol compound may comprise an alkoxylated (preferably ethoxylated) fatty alcohol compound comprising an alcohol residue derived from a C8 to C12 fatty alcohol and an alkylene oxide residue (preferably an ethylene oxide residue), wherein the average number of alkylene oxide groups per fatty alcohol is 4 to 8. In other words, the alkoxylated alcohol compound may have the formula A-(RO)ₙ—H wherein A is the residue of a C8 to C12 fatty alcohol, RO is an alkylene oxide (preferably ethylene oxide) residue (i.e. wherein R represents an alkylene, preferably ethylene, moiety) and n is an average value of 4 to 8.

An example of a suitable ethoxylated fatty alcohol compound is C9-C11 pareth-6 (which may be sold as Neodol 91-6).

An example of a suitable alkoxylated diol is OGI-9066 (available from Specialty Intermediates).

For example, the alkoxylated alcohol compound may comprise an alkoxylated (preferably ethoxylated) alkyl phenol compound comprising an alcohol residue derived from a C6 to C15, such as a C6 to C12 alkyl phenol and an alkylene oxide residue (preferably an ethylene oxide residue), wherein the average number of alkylene oxide groups per alkylphenol is 8 to 12. In other words, the alkoxylated alcohol compound may have the formula A-(RO)ₙ—H wherein A is the residue of a C6 to C15, such as a C6 to C12, alkyl phenol, RO is an alkylene oxide (preferably ethylene oxide) residue (i.e. wherein R represents an alkylene, preferably ethylene, moiety) and n is an average value of 8 to 12. References to a C6 to C15 alkyl phenol and suchlike are intended to refer to compounds in which the alkyl group has from 6 to 15 carbon atoms. An example of a suitable ethoxylated alkyl phenol compound is ethoxylated nonylphenol (for example ethoxylated nonylphenol with an average of 9 or 9.5 moles ethylene oxide, commercially sold as N-9 or N-9.5).

Examples of suitable alkoxylated amine compounds may comprise an alkylene oxide residue and a residue of a polyamine. Suitable polyamines (from which the residue (A above) may be derived) may be selected from any compound including two or more amine groups. Preferably the polyamine is a (poly)alkylene polyamine (by which is meant an alkylene polyamine or a polyalkylene polyamine; including in each case a diamine, within the meaning of “polyamine”). Suitable, the polyamine may be a (poly)alkylene polyamine in which the alkylene component has from 1 to 6, preferably from 1 to 4, most preferably from 2 to 3, carbon atoms. Most preferably the polyamine is a (poly) ethylene polyamine (that is an ethylene polyamine or a polyethylene polyamine). Suitably, the polyamine may have from 2 to 15 nitrogen atoms, preferably from 2 to 10 nitrogen atoms, more preferably from 2 to 8 nitrogen atoms.

Suitable polyamines (from which the residue (A above) may be derived) may, for example, be selected from ethylenediamine, diethylenetriamine, triethylenetetramine, tetraethylenepentamine, pentaethylene-hexamine, hexaethyleneheptamine, heptaethyleneoctamine, propane-1,2-diamine, 2(2-amino-ethylamino)ethanol, N′,N′-bis(2-aminoethyl) ethylenediamine (N(CH₂CH₂NH₂)₃), diphenyl 4, 4′-diamine, diamino naphthalene, phenylene diamine, xylene diamine, 1,2-diaminopropane and 1,3-diaminopropane, 1,4-diaminobutane, 1,5-diamino pentane and 1,6-diamino hexane. Preferably the polyamine (from which the residue (A above) may be derived) may be ethylenediamine.

The one or more alkoxylated amine compounds may be selected from one or more compounds of formula (I):

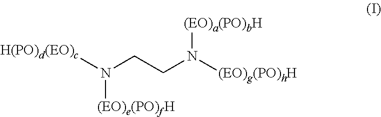

wherein EO represents an ethylene oxide residue, PO represents a propylene oxide residue and at least one of a, b, c, d, e, f, g and h is not 0.

The compounds of formula (I) may be prepared by reaction of ethylene diamine with ethylene oxide and propylene oxide (when both present) in any combination thereof and in any order, i.e. so as to provide compounds of formula (I) in which the ethylene oxide and propylene oxide residues may be present in any combination and in any order as bonded to the nitrogen of the amine group. The ethylene oxide and propylene oxide residues may be present in blocks in the compounds of formula (I).

Preferably each of a, b, c, d, e, f, g and h is at least one. Preferably the sum of a, b, c, d, e, f, g and h is from 10 to 500, suitably from 20 to 250, preferably from 40 to 200, more preferably from 50 to 150.

The skilled person will appreciate that polymeric compounds of formula (I) are usually in the form of mixtures.

Some suitable alkoxylated amine compounds for use herein are described in U.S. Pat. No. 6,838,422.

The additive composition may comprise the one or more alkoxylated alcohol and/or amine compounds (when present) in any suitable amount. For example, the additive composition may comprise at least 1 wt % of the one or more alkoxylated alcohol and/or amine compounds, and/or the additive composition may comprise up to 5 wt % of the one or more alkoxylated alcohol and/or amine compounds (when present). The additive composition may, for example, comprise from 1 to 5 wt % of the one or more alkoxylated alcohol and/or amine compounds (when present).

By a polymeric wax inhibitor we mean a polymer that acts to inhibit the formation of wax in a fluid and/or to disperse wax that is present in a fluid. Suitably the polymeric wax inhibitor (i.e. present as an additional additive) is not produced by microorganisms.

Any suitably polymeric wax inhibitor may be included in the additive composition. For example, the polymeric wax inhibitor may be independently selected from one or more of an alpha-olefin maleic anhydride copolymer or a derivative thereof, an alkylphenol resin and an ethylene vinyl acetate copolymer or a derivative thereof.

The additive composition may comprise the one or more polymeric wax inhibitors (when present) in any suitable amount. For example, the additive composition may comprise at least 5 wt %, such as at least 7 wt %, of the one or more polymeric wax inhibitors (when present) and/or the additive composition may comprise up to 15 wt %, such as up to 10 wt % of the one or more polymeric wax inhibitors (when present). The additive composition may, for example, comprise from 5 to 15 wt %, such as from 7 to 10 wt % of the one or more polymeric wax inhibitors (when present).

By an alpha-olefin maleic anhydride copolymer we mean a copolymer comprising, consisting essentially of or consisting of, maleic anhydride derived units and alpha-olefin derived units.

The alpha-olefin maleic anhydride copolymer may be an alternating copolymer and may be prepared by reacting maleic anhydride with an alpha-olefin. Means for carrying out such reactions will be well known to those skilled in the art and are described, for example in U.S. Pat. Nos. 4,240,916, 3,560,456 and 4,151,069. For example, methods for carrying out free-radical polymerisation of alpha-olefins with maleic anhydride will be well known to those skilled in the art and may use well known free-radical initiators, such as those based on peroxides or azo compounds, for example di-tert-butyl peroxide, tert-butyl peroxypivalate or azobisisobutyronitrile. Suitable temperature and pressure ranges are well known, such as temperatures of from 50 to 150° C. at standard pressure. The reactions are suitably performed in solvents such as aromatic hydrocarbons.

The alpha-olefin maleic anhydride copolymer may suitably be prepared by reacting maleic anhydride with an alpha-olefin in a molar ratio of from 3:1 to 1:3, preferably 2:1 to 1:2, more preferably from 1.5:1 to 1:1.5, for example about 1:1.

The alpha-olefin may suitably have from 6 to 40 carbon atoms, preferably from 10 to 36 carbon atoms, preferably from 12 to 36 carbon atoms.

Suitable alpha-olefins for preparing the alpha-olefin maleic anhydride copolymers may include 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octa-decene, 1-nonadecene, 1-eicosene, 1-heneicosene, 1-docosene, 1-tricosene, 1-tetracosene, 1-triacontene, 1-tetracontene, 1-pentacontene and mixtures thereof. For example, linear alpha-olefins having from 12 to 30, for example 16 to 24, carbon atoms, and mixtures thereof may be preferred.

To form the alpha-olefin maleic anhydride copolymer a mixture of alpha-olefins may be used. For example, a mixture of alpha-olefins having 20 to 28, such as 20 to 24, carbon atoms or having 22 to 28, such as 24 to 28 or 26 to 28 carbon atoms may be used. For example, a mixture of alpha-olefins having at least 30 carbon atoms may be used. Combinations of alpha-olefins having 20 to 28, such as 20 to 24, carbon atoms or having 22 to 28, such as 24 to 28 or 26 to 28 carbon atoms and alpha-olefins having at least 30 carbon atoms may be used.

The alpha-olefin maleic anhydride copolymer directly obtained from the reaction of an alpha-olefin and maleic anhydride comprises alkyl chains and anhydride functional groups. The anhydride groups may be further reacted to provide a derivative of an alpha-olefin maleic anhydride copolymer. For example, the anhydride groups may be hydrolysed to provide carboxylic acid functional groups. The anhydride and/or hydrolysed acid product may be partially or fully further functionalised, for example by reaction with amines and/or alcohols to incorporate ester and/or amide and/or imide functional groups and/or amine salts into the copolymer. For example, the anhydride and/or hydrolysed acid product may be partially or fully further functionalised by reaction with alcohols (such as alcohols having 20 to 28 carbon atoms) to incorporate ester functional groups into the copolymer. Suitable alcohols for reaction with the anhydride and/or hydrolysed acid product include saturated and unsaturated fatty alcohols, and mixtures thereof.

A further functionalised anhydride and/or hydrolysed acid product may comprise a mixture of functional groups deriving from one anhydride and/or carboxylic acid functional group. For example, the further functionalised product may comprise a half ester/half amide, a half ester/half amine salt, and half amine salt/half amide. For example, a half ester/half amide may be prepared by reacting with one mole (based on the anhydride) of an ester to ring open and make the half ester with a free carboxylic acid group and then reacting with a second mole of an amine to convert the free acid into an amide or an amine salt.

Preferred alpha-olefin maleic anhydride copolymers for use herein have a number average molecular weight of from 1000 to 50000, preferably from 2000 to 40000, suitably from 2500 to 30000, for example from 3000 to 25000. Preferably the alpha-olefin maleic anhydride copolymer has a number average molecular weight of from 5000 to 20000, such as from 5000 to 10000, preferably from 8000 to 15000.

The additive composition may comprise the one or more alpha-olefin maleic anhydride copolymers and derivatives thereof (when present) in any suitable amount. For example, the additive composition may comprise at least 5 wt %, such as at least 7 wt %, of the one or more alpha-olefin maleic anhydride copolymers and derivatives thereof (when present) and/or the additive composition may comprise up to 15 wt %, such as up to 10 wt % of the one or more alpha-olefin maleic anhydride copolymers and derivatives thereof (when present). The additive composition may, for example, comprise from 5 to 15 wt %, such as from 7 to 10 wt % of the one or more alpha-olefin maleic anhydride copolymers and derivatives thereof (when present).

Suitable alkylphenol resins include alkylphenol-aldehyde resins, for example those described in paragraphs [0017] to [0038] of US2007221539. Compounds derived from C3 to C40, such as from C3 to C12, alkyl or alkenyl phenols, especially nonylphenol, are particularly preferred. Optionally the alkylphenol resins may include a polyamine, such as a polyethylene polyamine.

Suitable ethylene vinyl acetate copolymers are, for example, as described in U.S. Pat. No. 4,481,013 and paragraphs [0026] to [0032] of US20170233670.

The additive composition may comprise one or more further additional additives, for example which may be independently selected from a solvent, a winterising agent, a pH adjusting agent, a chelating agent, a binding agent, a demulsifier compound, a preservative and a stabiliser (including mixtures thereof). Suitable amounts of such additional additives (when present) would be well known to persons skilled in the art.

Examples of suitable solvents include water, diesel, naphtha, alcohols (such as n-propanol, isopropyl alcohol and isopropanolamine), alkanes (such as n-hexane), aromatic hydrocarbons (such as benzene, toluene, xylene, kerosene and a C11-C14 aromatic hydrocarbon), terpenes (such as mono-terpenes, for example pinene and limonene) and ethers (such as ethylene glycol monobutyl ether and 2-butoxyethanol, also known as butyl cellosolve) (and mixtures thereof). The terpene (when present) may be provided as part of a natural oil, for example orange oil or pine oil and may be present as one isomer or a mixture of isomers. Suitable amounts of solvent(s) range from 20 to 80 wt %, such as from 20 to 70 wt % or from 20 to 65 wt %.

Examples of suitable winterising agents may include methanol. Suitable amounts of winterising agents (when present) range from 0.1 to 20 wt %, such as from 1 to 20 wt %.

Examples of suitable stabilisers may include isopropanol and ethylene glycol monobutyl ether. Suitable amounts of stabilisers (when present) range from 1 to 20 wt %.

Examples of suitable pH adjusting agents may include caustic soda, cyclohexylamine and phosphoric acid. Suitable amounts of pH adjusting agents range from 0.25 to 2 wt %.

Examples of suitable chelating agents may include iron chelating agents such as citric acid and gluconic acid. Suitable amounts of chelating agents range from 5 to 20 wt %.

Examples of suitable binding agents may include isopropanol and ethylene glycol. Suitable amounts of binding agents range from 1 to 35 wt %.

Examples of suitable demulsifier compounds include resins, polyols (such as propylene glycol), polyol esters, sulfonate, polyglycols (such as polyethylene glycol), polymerised polyols and diepoxide compounds. Suitable amounts of additional demulsifier compounds range from 1 to 5 wt %.

References herein to the additive composition comprising a specified wt % of a certain component, for example of a solvent, are intended to refer to the total of that particular component therein. For example, when the additive composition comprises two or more different solvents, the wt % provided relates to the total of those two or more solvents in the additive composition.

The additive composition may, for example, comprise from 0.1 to 15 wt % of the one or more biosurfactants and from 1 to 60 wt %, such as from 2 to 40 or from 2 to 38 wt %, of the one or more additional additives as defined herein.

The additive composition may, for example, comprise from 0.1 to 15 wt % of the one or more biosurfactants and one or more additional additives independently selected from (i) a sulfonic acid or salt thereof, (ii) a polymeric wax inhibitor and (iii) an alkoxylated alcohol and/or amine compound, wherein when present the one or more additional additives are present in an amount of (i) from 1 to 40 wt % of the sulfonic acid or salt thereof, (ii) from 5 to 15 wt % of the polymeric wax inhibitor and (iii) from 1 to 5 wt % of the alkoxylated alcohol and/or amine compound.

The additive composition may, for example, comprise from 0.1 to 15 wt % of the one or more biosurfactants and from 1 to 40 wt % of one or more sulfonic acids or salts thereof.

The additive composition may, for example, comprise from 0.1 to 15 wt % of the one or more biosurfactants, from 1 to 40 wt % of one or more sulfonic acids or salts thereof and from 5 to 15 wt % of one or more polymeric wax inhibitors.

The additive composition may, for example, comprise from 0.1 to 15 wt % of the one or more biosurfactants, from 1 to 40 wt % of one or more sulfonic acids or salts thereof, (ii) from 5 to 15 wt % of one or more polymeric wax inhibitors and (iii) from 1 to 5 wt % of one or more alkoxylated alcohol and/or amine compounds.

The one or more biosurfactants may be admixed with/added to the fluid in any suitable amount. For example, the one or more biosurfactants may be admixed with/added to the fluid at a concentration of from 1 to 5,000 ppm, such as from 1 to 500 ppm, for example from 2 to 250 ppm.

The additive composition may be added to the fluid at a concentration of from 5 to 10,000 ppm, for example of from 10 to 1,000 ppm or preferably of from 50 to 300 ppm.

The invention will now be further described with reference to the following non-limiting examples.

### Example 1

The following additive compositions were purchased (when commercially available) or prepared by mixing together the components specified in Tables 1 to 11 (with Tables 8 to 11 providing comparative additive compositions).

Commercial biosurfactant formulation 1: 40-45 wt % benzene sulfonic acid, 15-35 wt % isopropanol, 2-10 wt % sophorolipid.

Commercial biosurfactant formulation 2: 20-50 wt % amine salt of benzene sulfonic acid, 2-10 wt % isopropanol (IPA), 2-10 wt % toluene, 30-40 wt % naphtha, 2-15 wt % sophorolipid.

TABLE 1
Composition 1

| Component | Amount (wt %) |
|---|---|
| Water | 20 |
| Isopropanol | 5 |
| Commercial biosurfactant formulation 1 | 75 |

TABLE 2
Composition 2

| Component | Amount (wt %) |
|---|---|
| Toluene | 25 |
| Commercial biosurfactant formulation 1 | 75 |

TABLE 3
Composition 3

| Component | Amount (wt %) |
|---|---|
| Toluene | balance |
| Isopropanol | 4 |
| C24-28 alpha olefin-maleic anhydride | 7.5-8.5 |
| copolymer esterified with C20-28 fatty | |
| alcohols | |
| Commercial biosurfactant formulation 2 | 75 |

TABLE 4
Composition 4

| Component | Amount (wt %) |
|---|---|
| Toluene | balance |
| Isopropanolamine | 4.42 |
| C10-16 alkylbenzenesulfonic acid, | 10.43-11.01 |
| isopropylamine salt | |
| C24-28 alpha olefin-maleic anhydride | 7.48-8.47 |
| copolymer esterified with C20-28 fatty | |
| alcohols | |
| Paraffin dispersant composition 1 | 10.54 |
| Commercial biosurfactant formulation 2 | 5 |

Paraffin dispersant composition 1 is a commercially available mixture comprising: 40-50 wt % toluene, 10-20 wt % DDBSA amine salt, 10-20 wt % propanediol propoxylated then ethoxylated, up to 10 wt % propanol, up to 10 wt % limonene, up to 2 wt % methanol and up to 2 wt % 1,2-propanediol.

TABLE 5
Composition 5

| Component | Amount (wt %) |
|---|---|
| Toluene | balance |
| Naphtha | 18.66 |
| Isopropanolamine | 4.42 |
| C10-16 alkylbenzenesulfonic acid, | 10.43-11.01 |
| isopropylamine salt | |
| C24-28 alpha olefin-maleic anhydride | 7.48-8.47 |
| copolymer esterified with C20-28 fatty | |
| alcohols | |
| Paraffin dispersant composition 1 | 10.54 |
| Commercial biosurfactant formulation 2 | 5 |

TABLE 6
Composition 6

| Component | Amount (wt %) |
|---|---|
| Kerosene | 26 |
| Solvent blend* | 21.10 |
| Xylene | 30 |
| Commercial biosurfactant 2 | 10 |
| Butyl cellosolve | 4 |

*commercial blend of 30-60 wt % toluene, 15-30 wt % n-hexane and 10-15 wt % methanol

TABLE 7
Composition 7

| Component | Amount (wt %) |
|---|---|
| Diesel | 33.34 |
| Solvent blend* | 33.33 |
| Commercial biosurfactant 2 | 33.33 |

*commercial blend of 30-60 wt % toluene, 15-30 wt % n-hexane and 10-15 wt % methanol.

TABLE 8
Comparative A

| Component | Amount (wt %) |
|---|---|
| Toluene lactol blend | 49.50 |
| Paraffin dispersant composition 1 | 21.10 |
| C10-16 alkylbenzenesulfonic acid, | 23.40 |
| isopropylamine salt | |
| Branched dodecyl benzenesulfonic acid | 6 |

TABLE 9
Comparative B

| Component | Amount (wt %) |
|---|---|
| Toluene | 32 |
| Paraffin dispersant composition 1 | 5 |
| C10-16 alkylbenzenesulfonic acid, | 5 |
| isopropylamine salt | |
| Branched dodecyl benzenesulfonic acid | 6 |
| Xylenes | 43 |
| Methanol | 15 |

TABLE 10
Comparative C

| Component | Amount (wt %) |
|---|---|
| Toluene | 54.1 |
| Paraffin dispersant composition 1 | 5.7 |
| C10-16 alkylbenzenesulfonic acid, | 6.4 |
| isopropylamine salt | |
| Lactol | 4.7 |
| Methanol | 7.3 |

TABLE 11
Comparative D

| Component | Amount (wt %) |
|---|---|
| Toluene | 75 |
| Branched dodecylbenzene sulfonic acid | 10 |
| Linear dodecyl benzene sulfonic acid | 15 |

A wax dispersant screening test was conducted according to the following method: 100 ml of produced water was filtered and added to a bottle along with a 1 g plug of wax. The bottle was then submerged in a water bath set at 82° C. until the wax sample had melted. The additive composition to be tested was then added, the bottle was removed from the water bath and agitated on a bottle shaker for 1 hour at ambient temperature.

The bottle was the visually assessed as to whether the wax remained dispersed, ideally in small particles the size of coffee grounds and a clear water. The results are shown in Table 12.

The wax was obtained from production formations within South and West Texas.

TABLE 12

| | Treat rate | | |
|---|---|---|---|
| Additive | (ppm by | | |
| Composition | volume) | Pass/Fail | Visual assessment of wax |
| Blank | | Fail | single large lump |
| Composition 1 | 200 | Pass | fine particles dispersed |
| | | | on the bottle |
| Composition 2 | 200 | Pass | fine particles dispersed |
| | | | on the bottle |
| Composition 3 | 500 | Pass | resembles a fine powder |
| Composition 4 | 200 | Pass | resembles a fine powder |
| Composition 5 | 200 | Pass | resembles a fine powder |
| Comparative A | 400 | Fail | mix of smaller and larger |
| | | | particles |
| Comparative B | 1000 | Fail | mix of smaller and larger |
| | | | particles |
| Comparative C | 500 | Fail | large lumps remain |
| Comparative D | 200 | Fail | mix of granules and small |
| | | | particles |

### Example 2

A paraffin solvency test was conducted according to the following method:

A bottle was filled with 10 ml of each of additive compositions 6 and 7 and a 1 g ball of paraffin wax was added. The bottle was then left for 1 to 2 hours without agitating.

The test was repeated using 10 ml of diesel instead of an additive composition as a comparative.

The results are shown in Table 13.

TABLE 13

| Composition | Observation |
|---|---|
| Diesel (comparative) | Only partial break down of wax |
| Composition 6 | Wax ball fully broken down |
| Composition 7 | Wax ball fully broken down |

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of controlling wax deposition within a fluid, the method comprising admixing an additive composition with the fluid, wherein the additive composition comprises one or more biosurfactants and one or more additional additives independently selected from (i) a sulfonic acid or salt thereof, (ii) a polymeric wax inhibitor and (iii) an alkoxylated alcohol and/or amine compound.

2. The use of an additive composition to control wax deposition within a fluid, wherein the additive composition comprises one or more biosurfactants and one or more additional additives independently selected from (i) a sulfonic acid or salt thereof, (ii) a polymeric wax inhibitor and (iii) an alkoxylated alcohol and/or amine compound.

3. An additive composition comprising one or more biosurfactants and one or more additional additives independently selected from (i) a sulfonic acid or salt thereof, (ii) a polymeric wax inhibitor and (iii) an alkoxylated alcohol and/or amine compound.

4. The method of claim 1, wherein the one or more biosurfactants are independently selected from a glycolipid, a lipopeptide, a phospholipid and a polymeric biosurfactant.

5. The method of claim 4, wherein the one or more biosurfactants are glycolipids.

6. The method of claim 5, wherein the one or more biosurfactants are independently selected from a rhamnolipid, a trehalolipid, a sophorolipid and a mannosylerythritol lipid, preferably wherein the one or more biosurfactants are sophorolipids.

7. The method of claim 4, wherein the one or more biosurfactants are lipopeptides, preferably wherein the one or more biosurfactants are independently selected from surfactin and lichenysin.

8. The method of claim 4, wherein the one or more biosurfactants are phospholipids.

9. The method of claim 4, wherein the one or more biosurfactants are polymeric biosurfactants, preferably wherein the one or more biosurfactants are independently selected from liposan, rufisan, emulsan and alasan.

10. The method of claim 1, wherein the additive composition comprises from 0.2 to 15 wt % of the one or more biosurfactants.

11. The method of claim 1, wherein the one or more biosurfactants are admixed with the fluid at a concentration of from 1 to 500 ppm, for example of from 2 to 250 ppm.

12. The method of claim 1, wherein the additive composition is added to the fluid at a concentration of from 50 to 300 ppm.

13. The method of claim 1, wherein wax deposition is controlled by inhibiting the formation of wax in the fluid and/or by dispersing wax that is present in the fluid.

14. The method of claim 1, wherein the wax comprises straight chain saturated hydrocarbons with carbon atoms ranging from C18 to C36.

15. The method of claim 1, wherein the fluid comprises a hydrocarbon selected from a residual fuel oil (such as high sulfur fuel oil, very low sulfur fuel oil and ultra low sulfur fuel oil), a distillate fuel oil, a bio-derived fuel oil, a cracked process stream, a synthetic fuel, a gas oil (such as vacuum gas oil, light heating oil, diesel and middle distillate) and a plastic pyrolysis oil.

16. The method of claim 1, wherein the fluid comprises a hydrocarbon selected from crude oil, heavy fuel oil, gasoline, kerosenes, diesel fuels, transformer oils, turbine oils, heating oils, marine fuels, bunker oils and lubricating oils, preferably crude oil.

17. An admixture comprising a fluid and an additive composition according to claim 3.

18. A method of making an admixture according claim 17, the method comprising admixing an additive composition of claim 3 and a fluid.
